(19) United States
(12) Patent Application Publication
(10) Pub. No.: US 2013/0069842 A1
(43) Pub. Date: Mar. 21, 2013

(54) ANTENNA APPARATUS FOR PORTABLE TERMINAL

(71) Applicants: Seung-Jun Lee, Seongnam-si (KR); Jae-Min Seo, Suwon-si (KR); Sung-Won Park, Suwon-si (KR); Jae-Sun Park, Suwon-si (KR)

(72) Inventors: Seung-Jun Lee, Seongnam-si (KR); Jae-Min Seo, Suwon-si (KR); Sung-Won Park, Suwon-si (KR); Jae-Sun Park, Suwon-si (KR)

(73) Assignee: SAMSUNG ELECTRONICS CO., LTD., Suwon-si (KR)

(21) Appl. No.: 13/615,219

(22) Filed: Sep. 13, 2012

(30) Foreign Application Priority Data
Sep. 20, 2011 (KR) 10-2011-0094642

(51) Int. Cl. H01Q 21/28

(52) U.S. Cl. 343/853

(57) ABSTRACT

An antenna apparatus for a portable terminal is configured to reduce interference. The antenna apparatus includes a first antenna and a second antenna spaced apart from the first antenna. The antenna apparatus also includes a filter coupled to the first antenna and the second antenna, and configured to increase an isolation between the first antenna and the second antenna by filtering signals transmitted through the first antenna and the second antenna. The antenna apparatus further includes a main board configured to process the filtered signals.

### CROSS-REFERENCE TO RELATED APPLICATION AND CLAIM OF PRIORITY

The present application is related to and claims the benefit under 35 U.S.C. §119(a) of a Korean patent application filed in the Korean Intellectual Property Office on Sep. 20, 2011 and assigned Serial No. 10-2011-0094642, the entire disclosure of which is hereby incorporated by reference.

### TECHNICAL FIELD OF THE INVENTION

The present disclosure relates to an antenna apparatus for a portable terminal.

### BACKGROUND OF THE INVENTION

With the development of electronics communication industries in recent years, a portable terminal has become a necessity of modern life as an important means for delivering information which changes rapidly. Therefore, the portable terminal is developed competitively by those skilled in the art to ensure more users. Further, since a communication service such as Global System for Mobile Communications (GSM), Personal Communications Services (PCS), Digital Multimedia Broadcasting (DMB), Wireless Local Area Network (WLAN), Wireless Broadband (WiBro), Long Term Evolution (LTE), Worldwide Interoperability for Microwave Access (WiMax), 802.11n, and the like, has already been provided, a portable terminal capable of using several communication services without being limited to any specific one service has increased in number.

In general, a portable terminal includes antennas capable of transmitting and receiving signals of the respective communication services. However, since several antennas are provided in a limited space, interference may occur between the antennas, which results in a problem of performance deterioration. FIG. 1 illustrates a perspective view of a conventional antenna apparatus. Referring to FIG. 1, a conventional antenna apparatus 100 includes a main board 110 for processing signals of respective communication service bands, and first and second antennas 120 and 130 for communicating with the main board 110 and for transmitting and receiving the signals of the respective communication service bands. The first and second antennas 120 and 130 may be attached to the main board 110, or may be fixed to a molding. To facilitate transmission and reception of the signals of the respective communication services, the two antennas 120 and 130 should be sufficiently spaced apart from each other. However, as illustrated, if the two antennas 120 and 130 are located close to each other, the two antennas 120 and 130 mutually interfere with each other, and disrupt the performance of the portable terminal.

### SUMMARY OF THE INVENTION

To address the above-discussed deficiencies of the prior art, it is a primary object to provide at least the advantages described below. Accordingly, an aspect of the present disclosure is to provide an antenna apparatus for a portable terminal capable of reducing mutual interference even if antennas are not placed to be spaced apart from each other.

Another aspect of the present disclosure is to provide an antenna apparatus for a portable terminal capable of ensuring performance by improving an isolation between neighboring antennas.

Another aspect of the present disclosure is to provide an antenna apparatus for a portable terminal capable of facilitating transmission and reception of signals in one communication service band or different communication service bands.

In accordance with an aspect of the present disclosure, an antenna apparatus for a portable terminal is provided. The antenna apparatus includes a first antenna and a second antenna spaced apart from the first antenna. The antenna apparatus also includes a filter coupled to the first antenna and the second antenna, and configured to increase an isolation between the first antenna and the second antenna by filtering signals transmitted through the first antenna and the second antenna. The antenna apparatus also includes a main board configured to process the filtered signals.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a perspective view of a conventional antenna apparatus;

FIG. 2 illustrates a perspective view of a portable terminal according to an embodiment of the present disclosure;

FIG. 3 illustrates a block diagram of a portable terminal according to an embodiment of the present disclosure;

FIG. 4 to FIG. 11 illustrate a structure of an antenna apparatus according to an embodiment of the present disclosure;

FIG. 12 illustrates a graph illustrating a Scattering (S) parameter of the conventional antenna apparatus; and

FIG. 13 illustrates a graph illustrating an S parameter of an antenna apparatus according to an embodiment of the present disclosure.

### DETAILED DESCRIPTION OF THE INVENTION

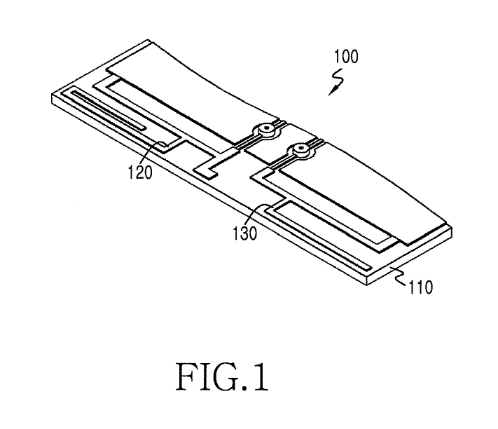

FIGS. 1 through 13, discussed below, and the various embodiments used to describe the principles of the present disclosure in this patent document are by way of illustration only and should not be construed in any way to limit the scope of the disclosure. Exemplary embodiments of the present disclosure will be described herein below with reference to the accompanying drawings. In the following description, well-known functions or constructions are not described in detail since they would obscure the disclosure in unnecessary detail. Also, the terms used herein are defined according to the functions of the present disclosure. Thus, the terms may vary depending on user's or operator's intension and usage. That is, the terms used herein are to be understood based on the descriptions made herein.

The present disclosure relates to an antenna apparatus for a portable terminal capable of improving an isolation between antennas. The antenna apparatus of the present disclosure does not experience performance deterioration even if antennas are not placed to be spaced apart from each other, and smoothly transmits and receives a signal of a corresponding communication service band.

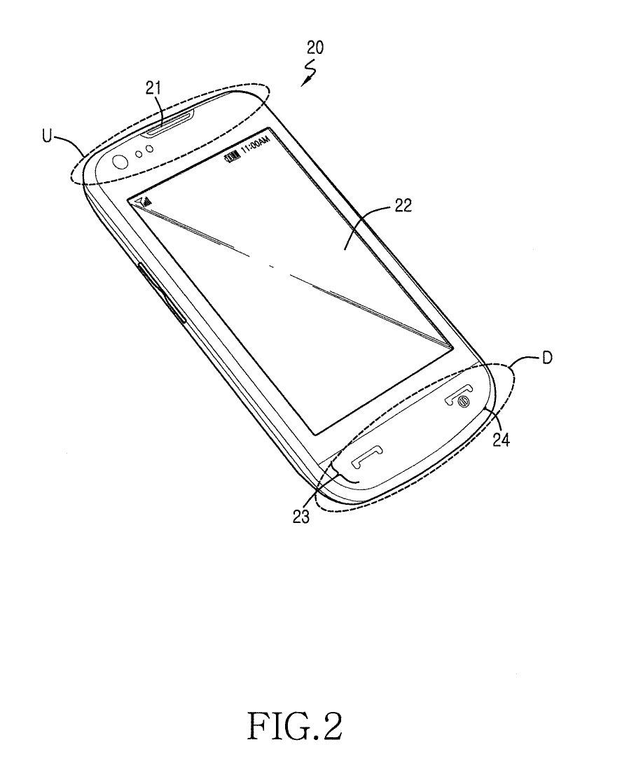

FIG. 2 illustrates a perspective view of a portable terminal according to an embodiment of the present disclosure.

Referring to FIG. 2, a portable terminal 20 includes a speaker 21 for outputting an electrical signal into an audio signal, a display 22 for outputting an electrical signal into a video signal, a microphone 24 for converting an audio signal into an electrical signal, and an input key 23. The display 22 may be a Liquid Crystal Display (LCD), a touch screen in which a touch panel is further attached to the LCD, or any other suitable display.

The terminal 20 includes an antenna apparatus for performing wireless communication, and has the following structure. The antenna apparatus of the present disclosure includes at least two antennas for transmitting and receiving a signal of a corresponding communication service band and a main board for processing a signal transmitted through the antennas. The main board is a board which contains a basic circuit and components. The main board allows a configuration of an execution environment of the portable terminal and maintains information thereof, allows the portable terminal to operation reliably, and allows to facilitate data input and output exchange of all devices of the portable terminal. The main board includes a communication module for processing signals transmitted through the antennas.

The antennas are situated at either an upper portion U or a lower portion D of the terminal. Since a user typically grabs a lateral portion of the terminal, it is often not preferable to place the antennas to the lateral portion of the terminal.

In an embodiment, the antenna apparatus of the present disclosure can ensure its performance even if the antennas are located close to each other since an isolation between the antennas can be improved. The antenna apparatus of the present disclosure includes a filter for removing an interference signal between the antennas, thereby achieving a desired result. The respective antennas of the antenna apparatus of the present disclosure can transmit and receive signals of different communication service bands, or can transmit and receive signals of one communication service band.

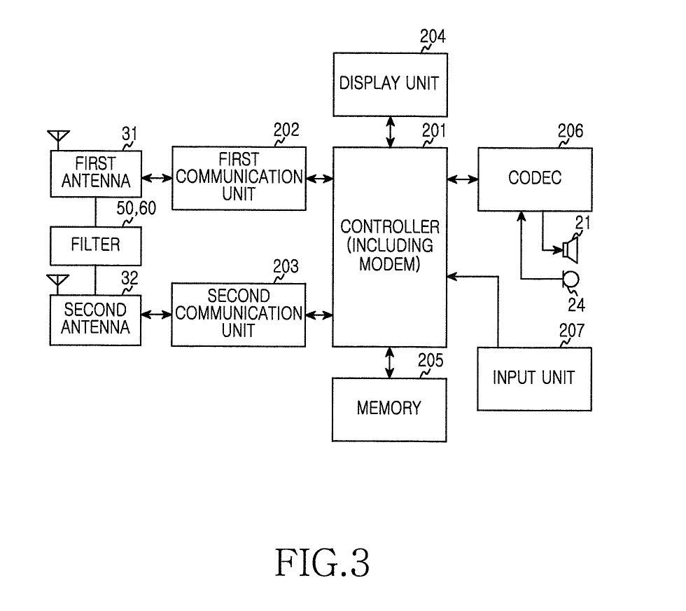

FIG. 3 illustrates a block diagram of a portable terminal according to an embodiment of the present disclosure.

Referring to FIG. 3, a controller 201 includes a modem for processing signals of communication units 202 and 203 to be described below. The communication units 202 and 203 can be implemented as one communication unit such that respective antennas can be processed individually.

The portable terminal according to this embodiment includes a first antenna 31 for transmitting and receiving a signal of a first communication frequency band and a second antenna 32 for transmitting and receiving a signal of a second communication frequency band. The first antenna 31 is electrically coupled to a first communication unit 202 for processing a signal of a first communication service band, and the second antenna 32 is electrically coupled to a second communication unit 203 for processing a signal of a second communication service band. An antenna having such a structure may be a well-known diversity antenna apparatus or a Multiple Input Multiple Output (MIMO) antenna apparatus.

In an embodiment, the portable terminal further includes a filter 50 for removing an interference signal generated between the first antenna 31 and the second antenna 32. Even if the first antenna 31 and the second antenna 32 are located close to each other due to the filter 50, an isolation between the two antennas can be ensured. The filter 50 has a structure in which the first antenna 31 and the second antenna 32 are electrically coupled, which will be described below in detail with reference to the accompanying drawing. Descriptions on a display unit 204, a memory 205, a codex 206, an input unit 207, a speaker 21, and a microphone 24 will be omitted since these components of the terminal are well-known components.

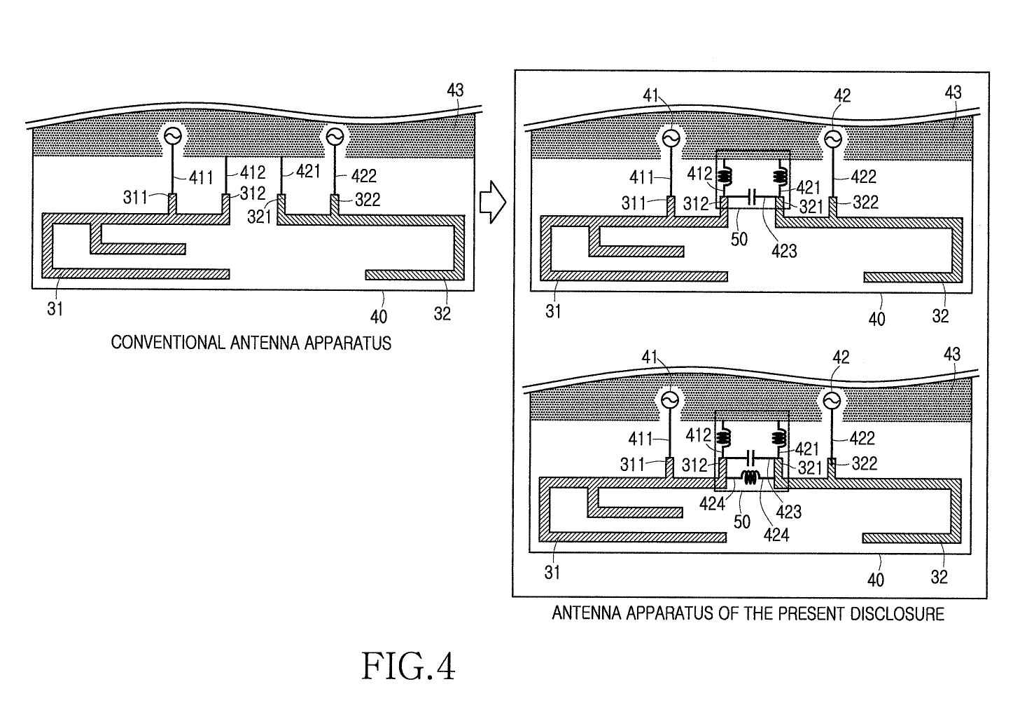

FIG. 4 to FIG. 11 illustrate a structure of an antenna apparatus according to an embodiment of the present disclosure. Referring to FIG. 4 to FIG. 11, the antenna apparatus of the present disclosure further includes a filter for removing an interference signal unlike the conventional antenna apparatus. The filter may include a circuit on which at least one of a passive element (e.g., an inductor and a capacitor), an active element (e.g., a diode), and a micro strip line is placed.

The antenna apparatus illustrated in FIG. 4 to FIG. 11 includes antennas which are spaced apart from each other and a main board which is electrically coupled to the antennas and which processes signals transmitted through the antennas. The antennas may be a thin metal film placed on the main board or may be a metal plate attached to a molding fixed to the main board. The antennas have a feeding node through which current is supplied and a ground node for grounding. The feeding node is electrically connected to a feeding line of the main board and the ground node is electrically connected to a around line of the main board. The feeding line is coupled to a communication unit for processing a signal of a corresponding communication service, and the ground line is coupled to a ground. If an element, such as an inductor or capacitor, is not placed to the feeding line or the ground line, a structure in which the feeding node or the ground node is directly coupled to the main board is also possible.

As described above, the antenna apparatus illustrated in FIG. 4 to FIG. 11 includes a first antenna and a second antenna, and the main board constitutes a first feeding line and a first ground line which are electrically coupled to the first antenna and a second feeding line and a second ground line which are electrically coupled to the second antenna. The first feeding line, the first ground line, the second feeding line, and the second ground line do not cross each other.

The antenna apparatus of FIG. 4 to FIG. 6 includes first and second antennas 31 and 32 for transmitting and receiving signals of different communication service bands, and includes a main board 40 for processing signals transmitted through the antennas 31 and 32. The main board 40 includes a first communication unit (not shown) for performing a first communication service by processing a signal transmitted through the first antenna 31 and a second communication unit (not shown) for performing a second communication service by processing a signal transmitted through the second antenna 32. The main board 40 constitutes a first feeding line 411 and a first ground line 412 electrically coupled respectively to a feeding node 311 and a ground node 312 of the first antenna 31. Further, the main board 40 constitutes a second feeding line 421 and a second ground line 422 electrically coupled respectively to a feeding node 321 and a ground node 322 of the second antenna 32.

The first and second feeding lines 411 and 421 of the antenna apparatus of FIG. 4 face each other, with the first ground line 412 and the second ground line 422 in the middle. The filter 50 may include a circuit on which at least one of a passive element, an active element, and a micro strip line is placed to the first ground line 412 or the second ground line 422. In addition, the filter 50 may include at least one line 423 for coupling the first ground line 412 and the second ground line 422 in a parallel manner, and may include a circuit on which at least one of a passive element, an active element, and a micro strip line is placed to the line 423. Further, the filter 50 includes at least one line 424 for electrically connecting the first antenna 31 and the second antenna 32, and may further include a circuit on which at least one of a passive element, an active element, and a micro strip line is placed to the line 424.

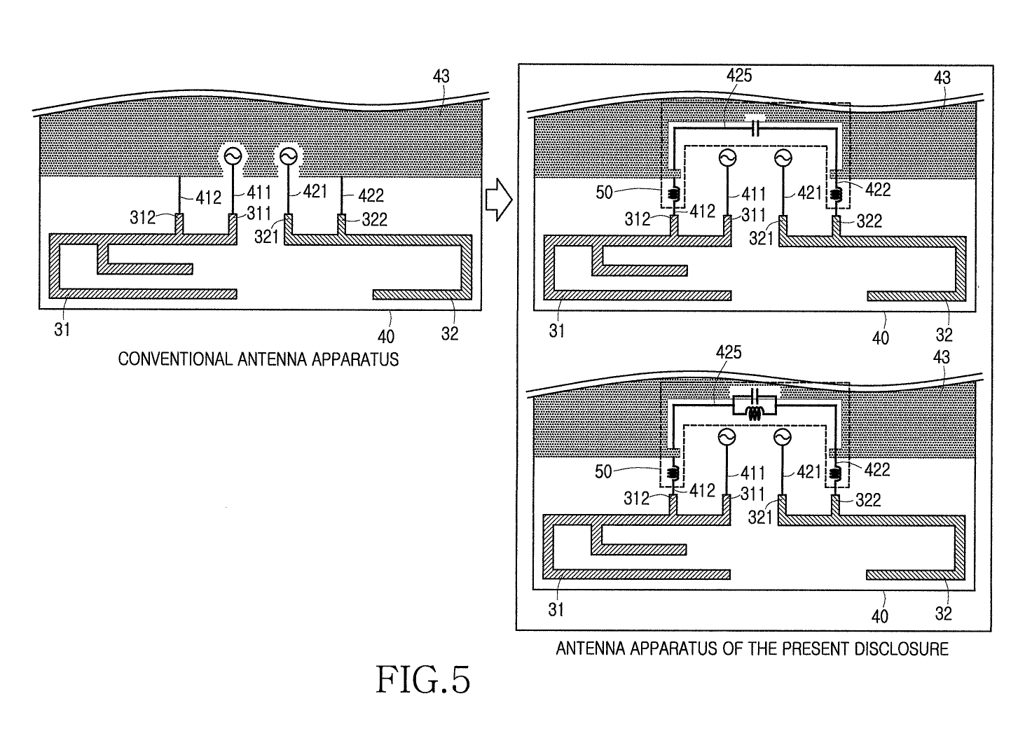

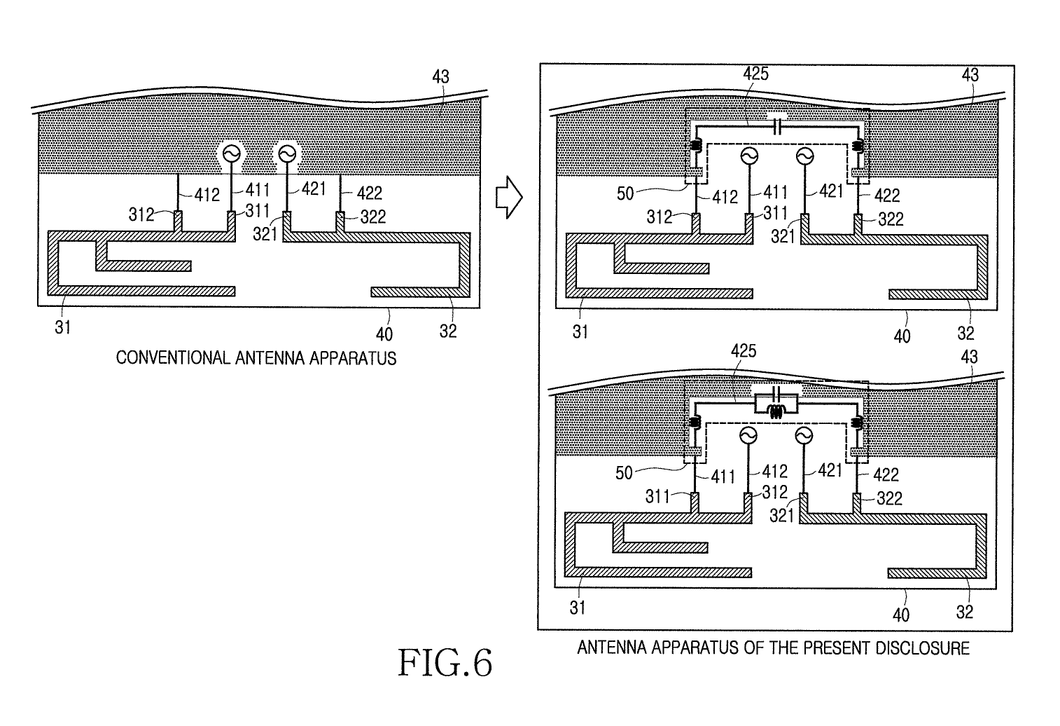

The first ground line 412 and the second ground line 422 of the antenna apparatus of FIG. 5 and FIG. 6 face each other, with the first feeding line 411 and the second feeding line 421 in the middle. The filter 50 may include a circuit on which at least one of a passive element, an active element, and a micro strip line is placed to the first ground line 412 and the second ground line 422. In addition, the filter 50 may include at least one line 425 for coupling the first ground line 412 and the second ground line 422 in a serial manner, and may include a circuit on which at least one of a passive element, an active element, and a micro strip line is placed to the line 425 in a parallel or serial manner.

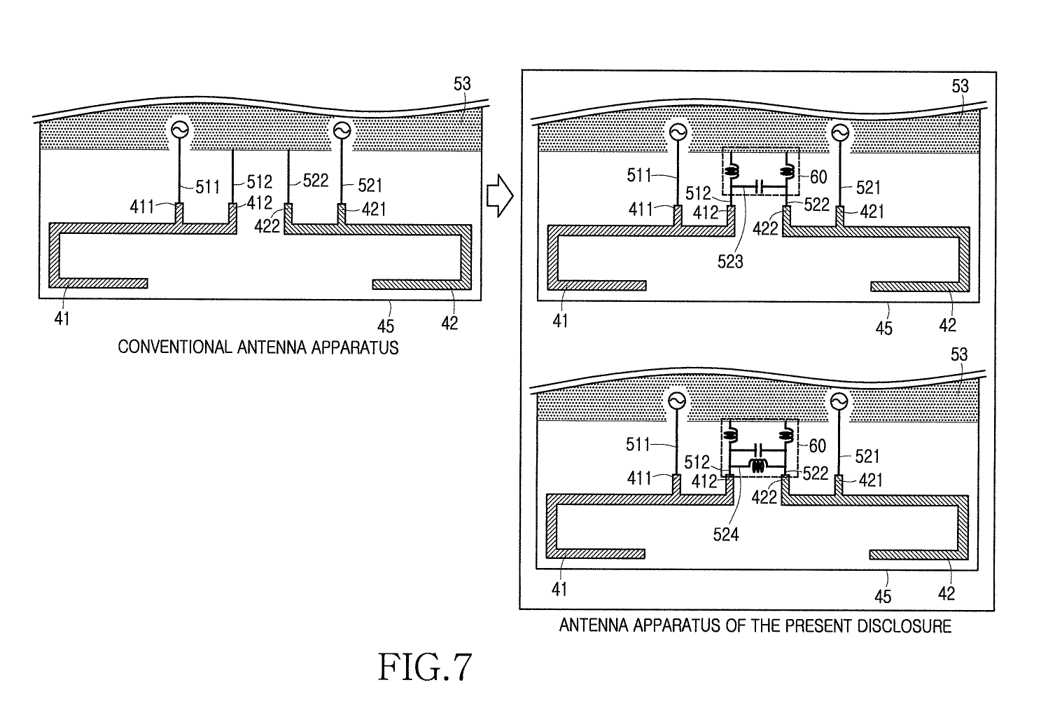

The antenna apparatus of FIG. 7 to FIG. 9 includes first and second antennas 41 and 42 for transmitting and receiving signals of one communication service band, and a main board 45 for processing signals transmitted through the antennas 41 and 42. The main board 45 further includes one communication unit for performing a corresponding communication service by processing signals transmitted through the two antennas 41 and 42. In an embodiment, the first and second antennas 41 and 42 are symmetrical to each other. The main board 45 constitutes a first feeding line 511 and a first ground line 512 electrically coupled respectively to a feeding node 411 and a ground node 412 of the first antenna 41. Further, the main board 45 constitutes a second feeding line 521 and a second ground line 522 electrically coupled respectively to a feeding node 421 and a ground node 422 of the second antenna 42.

The first and second feeding lines 511 and 521 of the antenna apparatus of FIG. 7 face each other, with the first ground line 512 and the second ground line 522 in the middle. The filter 60 may include one or more lines 523 and 524 for coupling the first ground line 512 or the second ground line 522 in a parallel manner, and may include a circuit on which at least one of a passive element, an active element, and a micro strip line is placed to the lines 523 and 524. Further, the filter 60 includes at least one line for electrically connecting the first antenna 41 and the second antenna 42, and may further include a circuit on which at least one of a passive element, an active element, and a micro strip line is placed to the line.

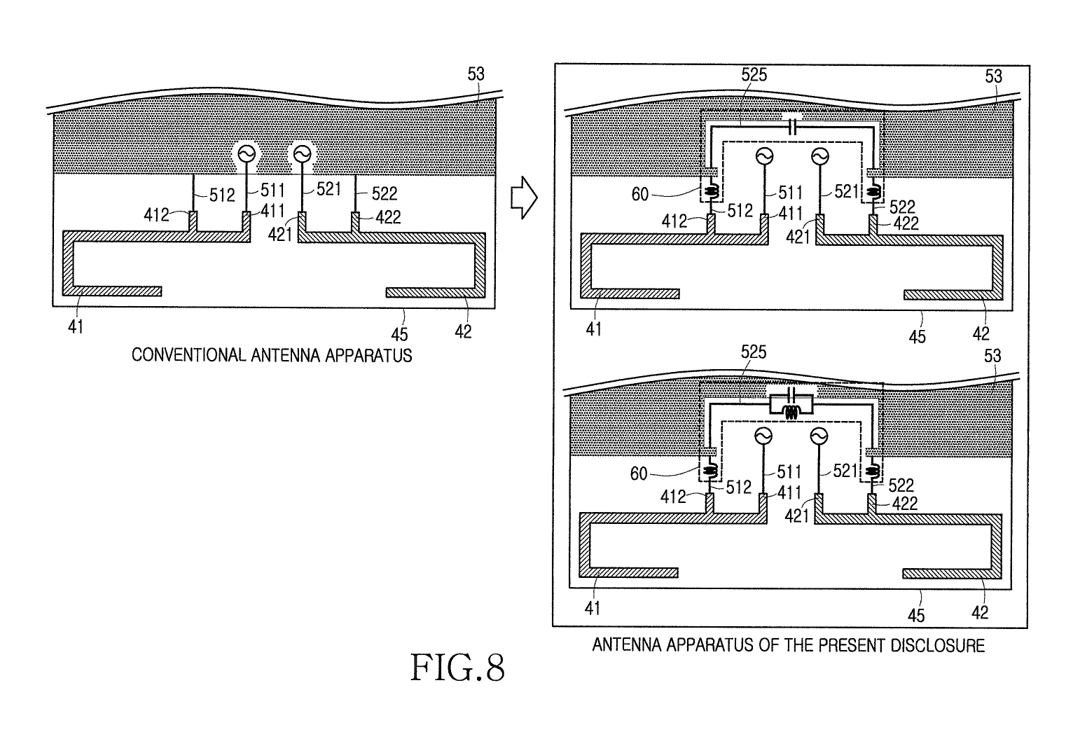

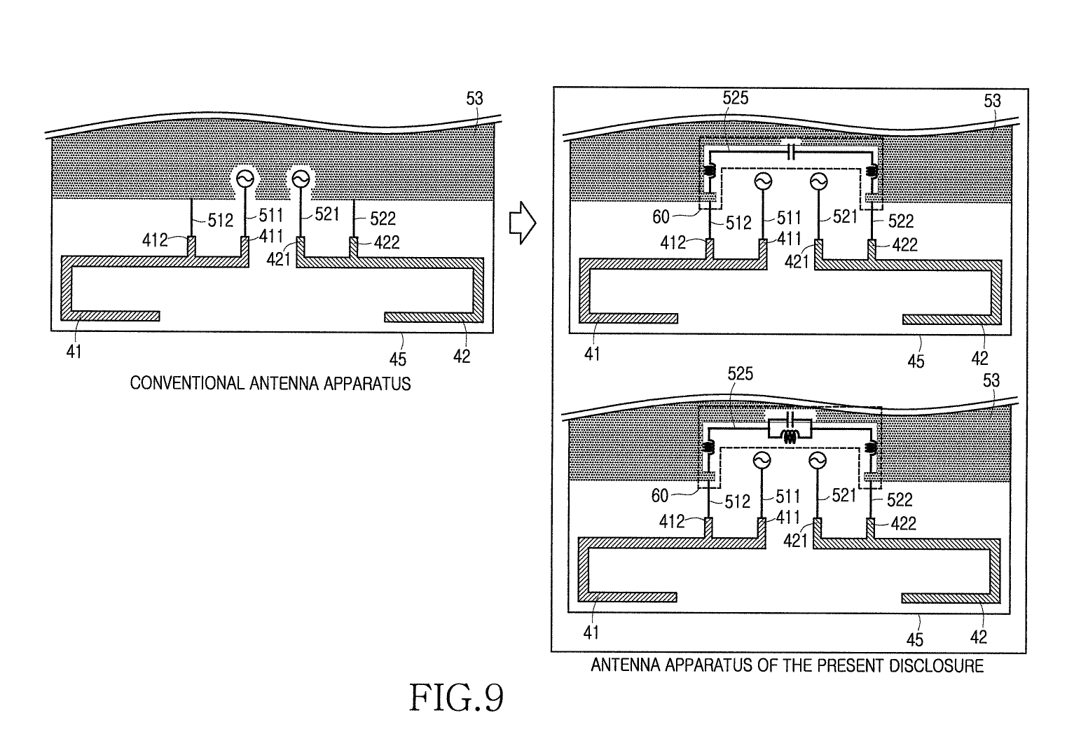

The first ground line 512 and the second ground line 522 of the antenna apparatus of FIG. 8 and FIG. 9 face each other, with the first feeding line 511 and the second feeding line 521 in the middle. The filter 60 may include a circuit on which at least one of a passive element, an active element, and a micro strip line is placed to the first ground line 512 and the second ground line 522. In addition, the filter 60 may include at least one line 525 for coupling the first ground line 512 and the second ground line 522 in a serial manner, and may include a circuit on which at least one of a passive element, an active element, and a micro strip line is placed to the line 525 in a parallel or serial manner.

The filters 50 and 60 of the antenna apparatus may be a Band Elimination Filter (BEF) for stopping a signal of a certain frequency band to improve an isolation between antennas. However, the present disclosure is not limited thereto, and thus the antenna apparatus according to embodiments of the present disclosure may further include one of a Low Pass Filter (LPF), a High Pass Filter (HFP), and a Band Pass Filter (BPF) to improve an antenna resonance characteristic in addition to the isolation.

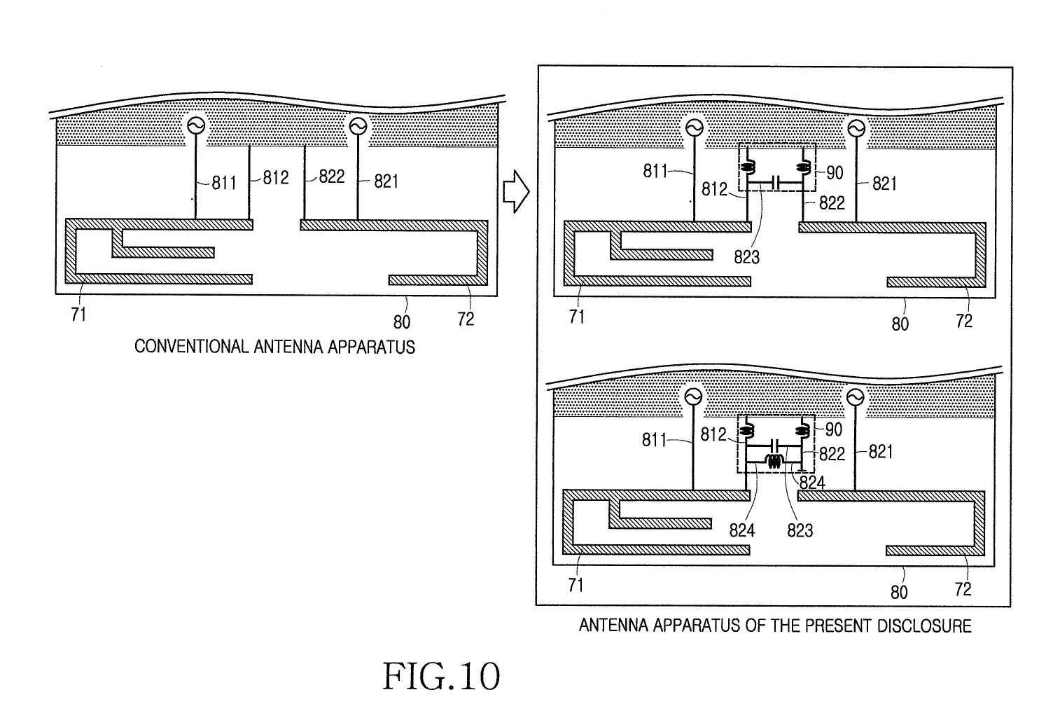

The antenna apparatus of FIG. 10 includes first and second antennas 71 and 72 for transmitting and receiving signals of different communication service bands and a main board 80 for processing signals transmitted through the antennas 71 and 72. The antenna apparatus of the present disclosure illustrated in FIG. 10 has a similar structure as that of the antenna apparatus of the present disclosure illustrated in FIG. 4. The antenna apparatus constitutes a first feeding line 811 and a first ground line 812 which are electrically coupled to the first antenna 71 and a second feeding line 821 and a second ground line 822 which are electrically coupled to the second antenna 72. However, the first antenna 71 and the second antenna 72 of the antenna apparatus of FIG. 10 do not additionally constitute a feeding node and a ground node. The present disclosure is not limited thereto, and thus the antenna apparatus consisting of the antennas which do not constitute the feeding node and the ground node may conform to the structure of FIG. 5 and FIG. 6. Importantly, the antenna apparatus of FIG. 10 constitutes a circuit on which at least one of a passive element, an active element, and a micro strip line is placed. The circuit constitutes a filter 90.

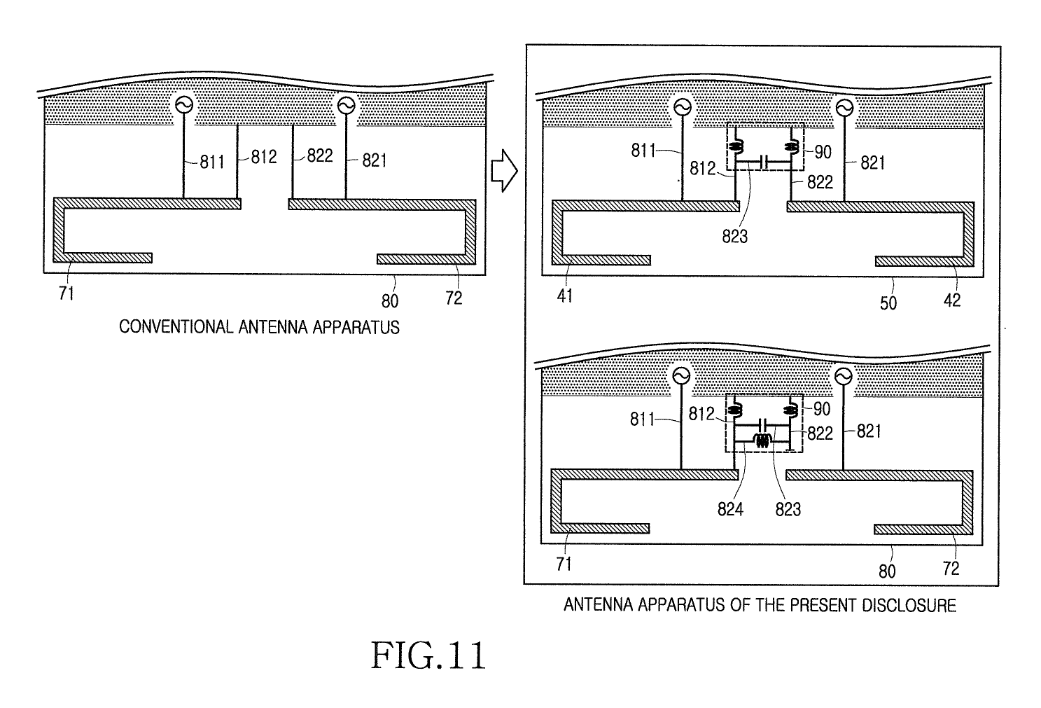

The antenna apparatus of FIG. 11 includes first and second antennas 71 and 72 which are symmetrical to each other and a main board 80 for processing signals transmitted through the antennas 71 and 72. The antenna apparatus of the present disclosure illustrated in FIG. 11 has a similar structure as that of the antenna apparatus of the present disclosure illustrated in FIG. 7. The antenna apparatus constitutes a first feeding line 811 and a first ground line 812 which are electrically coupled to the first antenna 71 and a second feeding line 821 and a second ground line 822 which are electrically coupled to the second antenna 72. However, the first antenna 71 and the second antenna 72 of the antenna apparatus of FIG. 11 do not additionally constitute a feeding node and a ground node. The present disclosure is not limited thereto, and thus the antenna apparatus consisting of the antennas which do not constitute the feeding node and the ground node may conform to the structure of FIG. 8 and FIG. 9. Importantly, the antenna apparatus of FIG. 11 constitutes a circuit on which at least one of a passive element, an active element, and a micro strip line is placed. The circuit constitutes a filter 90.

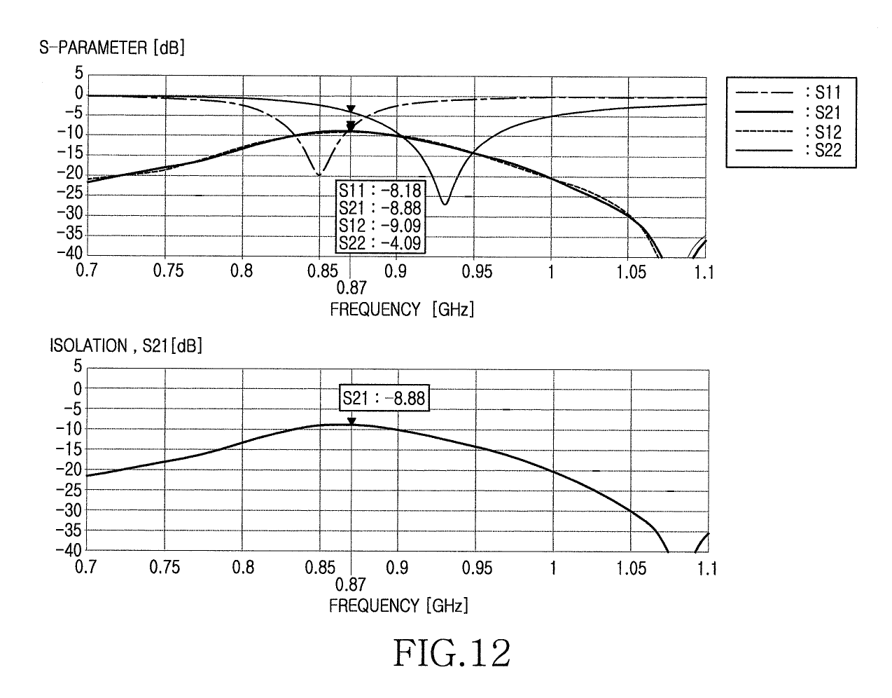

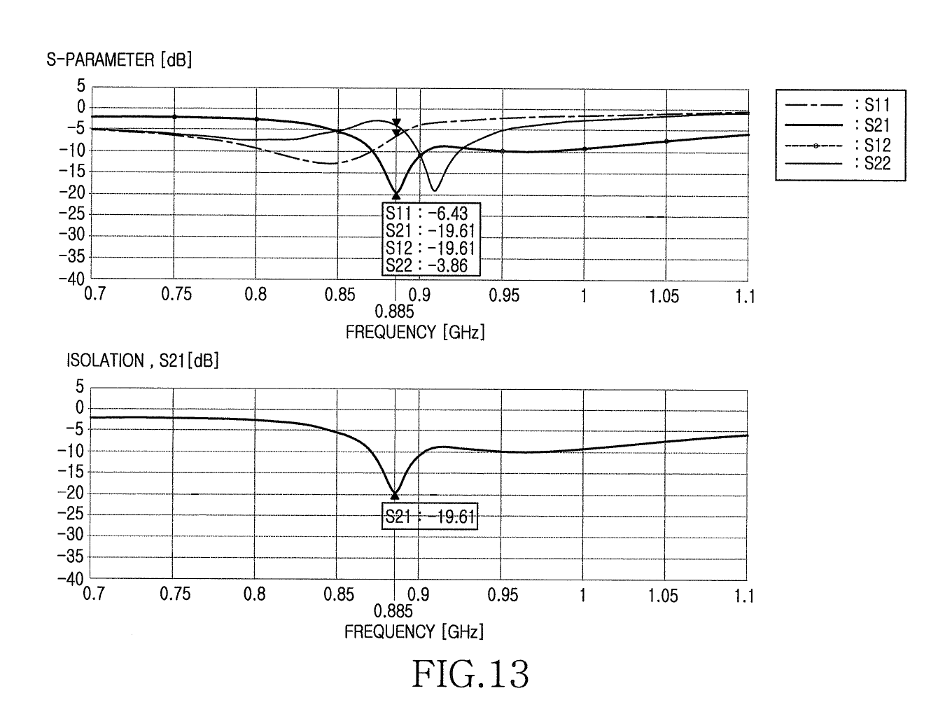

FIG. 12 illustrates a graph illustrating a Scattering (S) parameter of the conventional antenna apparatus. FIG. 13 illustrates a graph illustrating an S parameter of an antenna apparatus according to an embodiment of the present disclosure.

Referring to FIG. 12, among S parameters of the conventional antenna apparatus, an isolation has a value −8.88 dB at a predetermined resonance frequency 0.87 GHz. In contrast, referring to FIG. 13, among S parameters of the antenna apparatus according to this disclosure, an isolation has a value −19.61 dB at a predetermined resonance frequency 0.885 GHz. The antenna apparatus according to this disclosure shows an improved isolation in comparison with the conventional antenna apparatus.

In conclusion, the antenna apparatus of the portable terminal according to the present disclosure can ensure its performance by reducing mutual interference between antennas.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. An antenna apparatus for a portable terminal, comprising:
a first antenna;
a second antenna spaced apart from the first antenna;
a filter coupled to the first antenna and the second antenna, and configured to increase an isolation between the first antenna and the second antenna by filtering signals transmitted through the first antenna and the second antenna; and
a main board configured to process the filtered signals.

2. The antenna apparatus of claim 1, wherein the main board constitutes:
a first feeding line configured to supply current to the first antenna;
a second feeding line configured to supply current to the second antenna;
a first ground line configured to ground the first antenna; and
a second ground line configured to ground the second antenna.

3. The antenna apparatus of claim 2, wherein the filter comprises at least one third ground line configured to couple the first ground line and the second ground line in a serial or parallel manner, the filter further comprising a circuit on which at least one of a passive element, an active element, and a micro strip line is disposed adjacent to at least one of the first ground line, the second ground line, and the third ground line.

4. The antenna apparatus of claim 3, wherein the filter comprises at least one fourth line configured to couple the first antenna and the second antenna, and further comprises a circuit on which a passive element, an active element, and a micro strip line is disposed adjacent to the fourth line.

5. The antenna apparatus of claim 3, wherein the first feeding line, the second feeding line, the first ground line, and the second ground line do not cross each other.

6. The antenna apparatus of claim 5, wherein the first feeding line and the second feeding line face each other, with the first ground line and the second ground line between the first feeding line and the second feeding line.

7. The antenna apparatus of claim 5, wherein the first ground line and the second ground line face each other, with the first feeding line and the second feeding line between the first ground line and the second ground line.

8. The antenna apparatus of claim 1, wherein the first antenna and the second antenna transmit and receive signals in the same communication frequency band.

9. The antenna apparatus of claim 1, wherein the first antenna and the second antenna transmit and receive signals in different communication frequency bands.

10. The antenna apparatus of claim 1, wherein the first antenna and the second antenna are symmetrical to each other.

11. The antenna apparatus of claim 1, wherein the antenna apparatus is a diversity antenna apparatus or a Multiple Input Multiple Output (MIMO) antenna apparatus.

12. The antenna apparatus of claim 1, wherein the first antenna and the second antenna are disposed adjacent to one of an upper portion or a lower portion of the main board.

13. The antenna apparatus of claim 1, wherein at least one of the first antenna and the second antenna is a thin metal film placed on the main board.

14. The antenna apparatus of claim 1, wherein at least one of the first antenna and the second antenna is a metal plate attached to a molding fixed to the main board.

15. The antenna apparatus of claim 2, wherein at least one of the first antenna and the second antenna does not constitute a protrusion end electrically coupled to the feeding line or the ground line.

16. A portable terminal, comprising:
a display; and
an antenna apparatus, comprising:
a first antenna;
a second antenna spaced apart from the first antenna;
a filter coupled to the first antenna and the second antenna, and configured to increase an isolation between the first antenna and the second antenna by filtering signals transmitted through the first antenna and the second antenna; and
a main board configured to process the filtered signals.

17. The portable terminal of claim 16, wherein the main board constitutes:
a first feeding line configured to supply current to the first antenna;
a second feeding line configured to supply current to the second antenna;
a first ground line configured to ground the first antenna; and
a second ground line configured to ground the second antenna.

18. The portable terminal of claim 17, wherein the filter comprises at least one third ground line configured to couple the first ground line and the second ground line in a serial or parallel manner, the filter further comprising a circuit on which at least one of a passive element, an active element, and a micro strip line is disposed adjacent to at least one of the first ground line, the second ground line, and the third ground line.

19. The portable terminal of claim 18, wherein the filter comprises at least one fourth line configured to couple the first antenna and the second antenna, and further comprises a circuit on which a passive element, an active element, and a micro strip line is disposed adjacent to the fourth line.

20. The portable terminal of claim 18, wherein the first feeding line, the second feeding line, the first ground line, and the second ground line do not cross each other.
